(19) United States
(12) Patent Application Publication
(10) Pub. No.: US 2021/0192362 A1
(43) Pub. Date: Jun. 24, 2021

(54) INFERENCE METHOD, STORAGE MEDIUM STORING INFERENCE PROGRAM, AND INFORMATION PROCESSING DEVICE

(71) Applicant: FUJITSU LIMITED, Kawasaki-shi (JP)

(72) Inventor: YUSUKE OKI, Kawasaki (JP)

(73) Assignee: FUJITSU LIMITED, Kawasaki-shi (JP)

(21) Appl. No.: 17/111,555

(22) Filed: Dec. 4, 2020

(30) Foreign Application Priority Data
Dec. 20, 2019 (JP) 2019-230902

(51) Int. Cl. G06N 5/00; G06N 5/04; G06N 3/02; G06N 20/20

(52) U.S. Cl. CPC G06N 5/003; G06N 20/20; G06N 3/02; G06N 5/04

(57) ABSTRACT

An inference method is executed by a computer. The method includes: obtaining a learned model in which learning data having non-linear characteristics is learned by supervised learning; creating a decision tree that includes nodes and edges in which intermediate nodes are associated with branch conditions and terminal nodes are associated with clustered learning data; identifying a terminal node associated with classification target data by following the intermediate nodes and the edges of the created decision tree based on the inputted classification target data; and outputting a prediction result obtained by applying the learning data associated with the identified terminal node to the learned model as a prediction result of the identified terminal node.

### CROSS-REFERENCE TO RELATED APPLICATION

This application is based upon and claims the benefit of priority of the prior Japanese Patent Application No. 2019-230902, filed on Dec. 20, 2019, the entire contents of which are incorporated herein by reference.

### FIELD

The embodiments discussed herein are related to the inference technique.

### BACKGROUND

The classification using a learned model by the machine learning technique has been known to solve the problem in the classification of data having the non-linear characteristics. In the application to the fields of human resource and finance that desire the interpretation of which logic is used to obtain the classification result, there has been known an existing technique of classifying the data having the non-linear characteristics by using a decision tree, which is a model having high interpretability in the classification result.

Related techniques are disclosed in, for example, Japanese Laid-open Patent Publication Nos. 2010-9177 and 2016-109495.

### SUMMARY

According to an aspect of the embodiments, an inference method is executed by a computer. The method includes: obtaining a learned model in which learning data having non-linear characteristics is learned by supervised learning; creating a decision tree that includes nodes and edges in which intermediate nodes are associated with branch conditions and terminal nodes are associated with clustered learning data; identifying a terminal node associated with classification target data by following the intermediate nodes and the edges of the created decision tree based on the inputted classification target data; and outputting a prediction result obtained by applying the learning data associated with the identified terminal node to the learned model as a prediction result of the identified terminal node.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a system configuration;

FIG. 2 is a flowchart illustrating operation examples of a host learning device and a client learning device;

FIG. 3 is an explanatory diagram describing a learning model of the supervised learning;

FIG. 4 is an explanatory diagram describing the data classification using the learning model;

FIG. 5 is an explanatory diagram describing the creation of a decision tree;

FIG. 6 is a flowchart exemplifying processing of identifying representative data;

FIG. 7 is an explanatory diagram illustrating examples of a factor distance matrix and an error matrix;

FIG. 8A is an explanatory diagram describing the evaluation of the degree of influence on the error matrix;

FIG. 8B is an explanatory diagram describing the valuation of the degree of influence on the error matrix;

FIG. 8C is an explanatory diagram describing the data deletion according to the degree of influence on the error matrix;

FIG. 9 is an explanatory diagram describing an example of the last remaining data;

FIG. 10 is an explanatory diagram exemplifying the identification of representative data;

FIG. 11 is an explanatory diagram describing the replacement of classification scores in the decision tree;

FIG. 12 is an explanatory diagram describing the comparison between the existing technique and the present embodiment;

FIG. 13 is an explanatory diagram describing the comparison between the existing technique and the present embodiment; and

FIG. 14 is a block diagram illustrating an example of a computer that executes a program.

### DESCRIPTION OF EMBODIMENTS

In the related art, the classification using the decision tree in the above-described existing technique has a problem that the classification accuracy is lower than that of using other models such as a gradient boosting tree (GBT) and a neural network, although the interpretability is higher.

For example, in a case of classifying the pass or fail of an examination using the decision tree, two values of pass (100%) and fail (0%) are obtained from the decision tree as classification scores (certainty) related to the classification. Thus, with the decision tree, even when the result is classified as pass, how much is the certainty to be classified as pass is still unclear, and this causes the area under the receiver operating characteristic (ROC) curve (AUC), which is one of the representative characteristic evaluation indicators of the machine learning, to be low.

In one aspect, an object is to provide an inference method, a storage medium storing an inference program, and an information processing device having an excellent classification accuracy.

Hereinafter, an inference method, an inference program, and an information processing device according to an embodiment are described with reference to the drawings. In embodiments, the same reference numerals are used for a configuration having the same functions, and repetitive description is omitted. The inference method, the inference program, and the information processing device described in the embodiment described below are merely illustrative and not intended to limit the embodiment. The following embodiments may be combined as appropriate to the extent not inconsistent therewith.

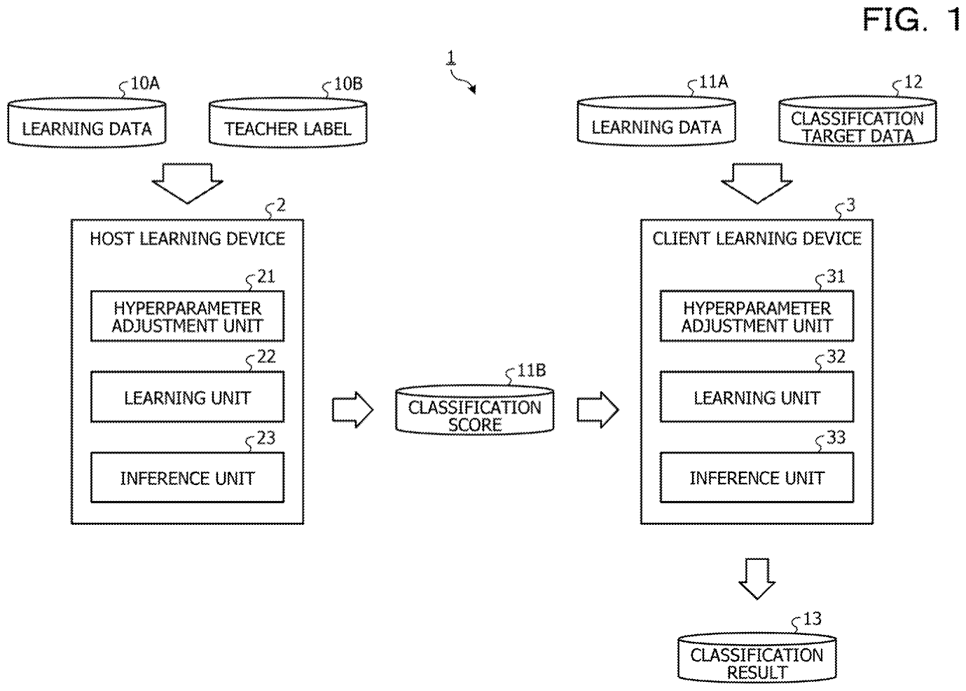

FIG. 1 is a block diagram illustrating an example of a system configuration. As illustrated in FIG. 1, an information processing system 1 includes a host learning device 2 and a client learning device 3. In the information processing system 1, the host learning device 2 and the client learning device 3 are used to perform the supervised learning with learning data 10A and 11A to which teacher labels 10B are applied. Then, in the information processing system 1, a model obtained by the supervised learning is used to classify classification target data 12, which is data having the non-linear characteristics, and obtain a classification result 13.

Although this embodiment exemplifies the system configuration in which the host learning device 2 and the client learning device 3 are separated from each other, the host learning device 2 and the client learning device 3 may be integrated as a single learning device. Specifically, the information processing system 1 may be formed as a single learning device and may be, for example, an information processing device in which a learning program is installed.

In this embodiment, here is exemplified for description a case where the pass or fail of an examination such as an entrance examination is classified based on the performance of an examinee that is an example of the data having the non-linear characteristics. For example, the information processing system 1 inputs the performances of Japanese, English, and so on of an examinee to the information processing system 1 as the classification target data 12 and obtains the pass or fail of the examination such as an entrance examination of the examinee as the classification result 13.

The learning data 10A and 11A are the performances of Japanese, English, and so on of examinees as samples. In this case, the learning data 11A and the classification target data 12 have the same data format. For example, when the learning data 11A is performance data (vector data) of English and Japanese of the sample examinees, the classification target data 12 is also the performance data (vector data) of English and Japanese of the subjects.

The data formats of the learning data 10A and the learning data 11A may be different from each other as long as the sample examinees are the same. For example, the learning data 10A may be image data of examination papers of English and Japanese of the sample examinees, and the learning data 11A may be the performance data (vector data) of English and Japanese of the sample examinees. In this embodiment, the learning data 10A and the learning data 11A are the completely same data. For example, the learning data 10A and 11A are both the performance data of English and Japanese of the sample examinees (examinee A, examinee B, . . . , examinee Z).

The host learning device 2 includes a hyperparameter adjustment unit 21, a learning unit 22, and an inference unit 23.

The hyperparameter adjustment unit 21 is a processing unit that adjusts hyperparameters related to the machine learning such as the batch size, the number of iterations, and the number of epochs to inhibit the machine learning using the learning data 10A from being overlearning. For example, the hyperparameter adjustment unit 21 tunes the hyperparameters such as the batch size, the number of iterations, and the number of epochs by the cross-validation of the learning data 10A or the like.

The learning unit 22 is a processing unit that creates a learning model that performs the classification by the machine learning using the learning data 10A. Specifically, the learning unit 22 creates a learning model such as a gradient boosting tree (GBT) and a neural network by performing the publicly-known supervised learning based on the learning data 10A and the teacher labels 10B applied to the learning data 10A as correct answers (for example, the pass or fail of the sample examinees). For example, the learning unit 22 is an example of an obtainment unit.

The inference unit 23 is a processing unit that performs the inference (the classification) using the learning model created by the learning unit 22. For example, the inference unit 23 classifies the learning data 10A by using the learning model created by the learning unit 22. For example, the inference unit 23 inputs the performance data of the sample examinees in the learning data 10A into the learning model created by the learning unit 22 to obtain the probability of the pass or fail of each examinee as a classification score 11B. Then, based on the classification scores 11B thus obtained, the inference unit 23 classifies the pass or fail of the sample examinees.

The inference unit 23 calculates a score (hereinafter, a factor score) of a factor of the obtainment of the classification result for the learning data 10k For example, the inference unit 23 calculates the factor score by using publicly-known techniques such as the local interpretable model-agnostic explanations (LIME) and the Shapley additive explanations (SNAP) which interpret that on what basis the classification by the machine learning model is performed. The inference unit 23 outputs the factor scores calculated for the corresponding examinees of the learning data 10A to the client learning device 3 with the classification scores 11B.

The client learning device 3 includes a hyperparameter adjustment unit 31, a learning unit 32, and an inference unit 33.

The hyperparameter adjustment unit 31 is a processing unit that adjusts hyperparameters related to the machine learning such as the batch size, the number of iterations, and the number of epochs to inhibit the machine learning using the learning data 11A from being overlearning. For example, the hyperparameter adjustment unit 21 tunes the hyperparameters such as the batch size, the number of iterations, and the number of epochs by the cross-validation of the learning data 11A or the like.

The learning unit 32 is a processing unit that performs the publicly-known supervised learning related to a decision tree by using the learning data 11A and the teacher labels 10B applied to the learning data 11A as correct answers. Specifically, the decision tree learned by the learning unit 32 includes multiple nodes and edges coupling the nodes, and intermediate nodes are associated with branch conditions (for example, conditional expressions of a predetermined data item). Terminal nodes in the decision tree are associated with labels of the teacher labels 10B that are, for example, the pass or fail of the examination.

Through the publicly-known supervised learning related to the decision tree, the learning unit 32 creates the decision tree by determining the branch conditions for the intermediate nodes so as to reach the terminal nodes associated with the labels applied to the teacher labels 10B for the corresponding sample examinees of the learning data 11A. For example, the learning unit 32 is an example of a creation unit.

The learning unit 32 performs the classification of the learning data 11A by the created decision tree to associate the terminal nodes with the learning data 11A classified to the corresponding terminal nodes, or associate the terminal nodes with the learning data 11A clustered to the terminal nodes.

The inference unit 33 is a processing unit that performs the inference (the classification) of the classification target data 12 using the decision tree learned by the learning unit 32. For example, the inference unit 33 identifies the terminal node associated with the classification target data 12 by following the edges of the conditions corresponding to the classification target data 12 out of the branch conditions of the intermediate nodes in the decision tree learned by the learning unit 32 until reaching any one of the terminal nodes.

The inference unit 33 outputs a prediction result (the classification score 116) of the learning model created by the learning unit 22 for the learning data 10A clustered to the identified terminal node as a prediction result of the identified terminal node. For example, the inference unit 33 is an example of an identification unit and an output unit.

In this way, for the classification target data 12, the inference unit 33 outputs as the classification result 13 the prediction result (the classification score 116) of the learning model created by the learning unit 22 for the terminal node identified by the decision tree with the label (for example, the pass or fail of the examination) of the terminal node.

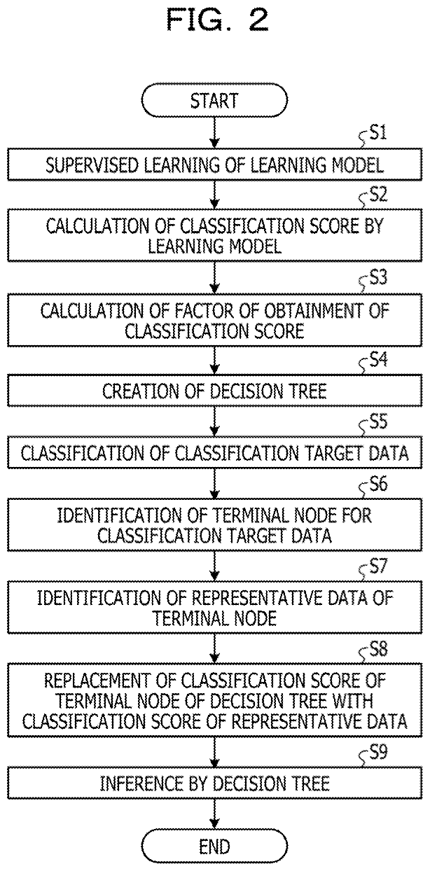

FIG. 2 is a flowchart illustrating operation examples of the host learning device 2 and the client learning device 3. As illustrated in FIG. 2, once the processing is started, the learning unit 22 performs the supervised learning of the learning model by using the learning data 10A and the teacher labels 106 applied to the learning data 10A as correct answers (S1).

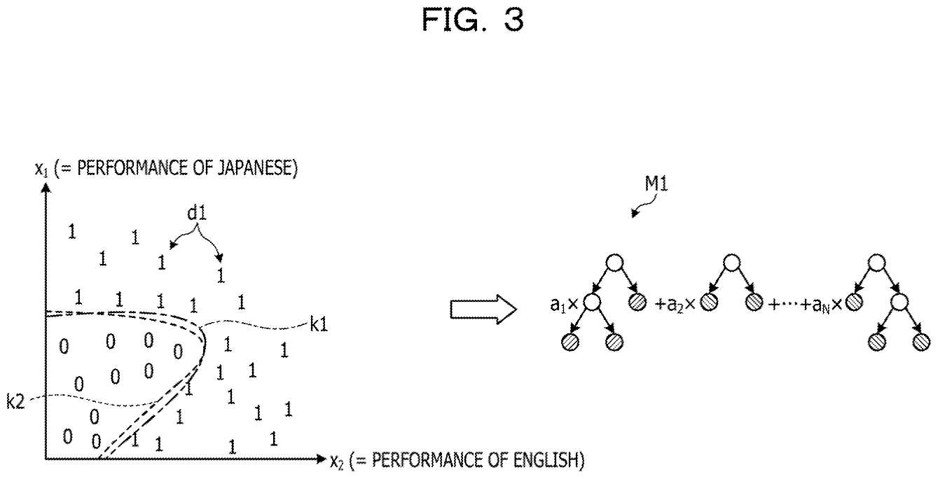

FIG. 3 is an explanatory diagram describing a learning model of the supervised learning. The left side of FIG. 3 illustrates distributions in a plane of a performance (x₁) of Japanese and a performance (x₂) of English for data d1 of the sample examinees included in the learning data 10A. “1” or “0” in the data d1 indicates a label of the pass or fail applied as the teacher label 106, while “1” indicates an examinee who passes, and “0” indicates an examinee who fails.

The learning unit 22 obtains a learning model M1 by adjusting weights (a₁, a₂, . . . , a_{N}) in the learning model M1 so as to make a boundary k2 closer to a true boundary k1 in the learning model M1 of a gradient boosting tree (GBT) that classifies the examinees into who passes and who fails, as illustrated in FIG. 3.

Referring back to FIG. 2 and following S1, the inference unit 23 classifies the learning data 10A by using the learning model M1 created by the learning unit 22 and calculates the classification score 11B of each of the sample examinees included in the learning data 10A (S2).

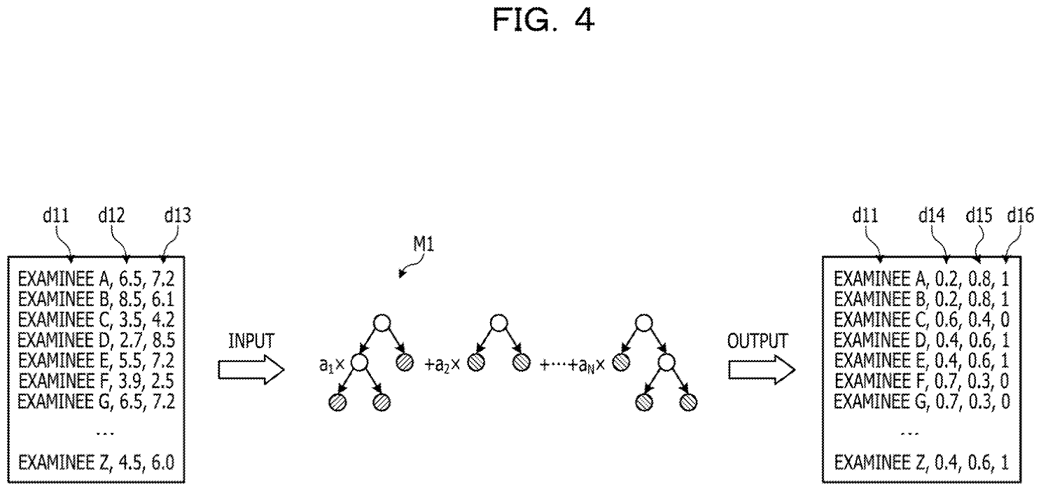

FIG. 4 is an explanatory diagram describing the data classification using the learning model M1. As illustrated in FIG. 4, the inference unit 23 inputs performances (Japanese) d12 and performances (English) d13 of corresponding examinees d11, which are the “examinee A”, the “examinee B”, . . . the “examinee Z”, into the learning model M1 to obtain outputs of fail rates d14 and pass rates d15 related to the classification of the pass or fail of the examinees dn. The fail rates d14 and the pass rates d15 are an example of the classification scores 118.

The inference unit 23 may determine classification results d16 based on the obtained fail rates d14 and pass rates d15. For example, the learning unit 22 sets “1” indicating the pass as the classification result d16 when the pass rate d15 is greater than the fail rate d14 and sets “0” indicating the fail as the classification result d16 when the pass rate d15 is not greater than the fail rate d14.

Referring back to FIG. 2, the inference unit 23 uses the publicly-known techniques such as the LIME and the SHAP that investigate the factor of the classification performed by the learning model M1 to calculate the factor of the obtainment of the classification score (the factor score) (S3).

For example, since the performance of the “examinee A” is (the performance of English, the performance of Japanese)=(6.5, 7.2), the “examinee A” is classified to the pass “1” with the performance being inputted in the learning model M1. With the publicly-known techniques such as the LIME and the SHAP, the inference unit 23 obtains the degrees of contribution of the performance of English and the performance of Japanese to the pass of the “examinee A” as the factor score indicating the factor of the classification. For example, the inference unit 23 obtains (the performance of English, the performance of Japanese)=(3.5, 4.5) as the degrees of contribution of the performance of English and the performance of Japanese to the pass of the “examinee A” as the factor score of the pass of the “examinee A”. Based on this factor score, it is possible to see that the performance of Japanese more contributes than the performance of English to the pass of the “examinee A”.

Then, the learning unit 32 uses the learning data 11A and the teacher labels 10B applied to the learning data 11A as correct answers to perform the publicly-known supervised learning and creates the decision tree (54).

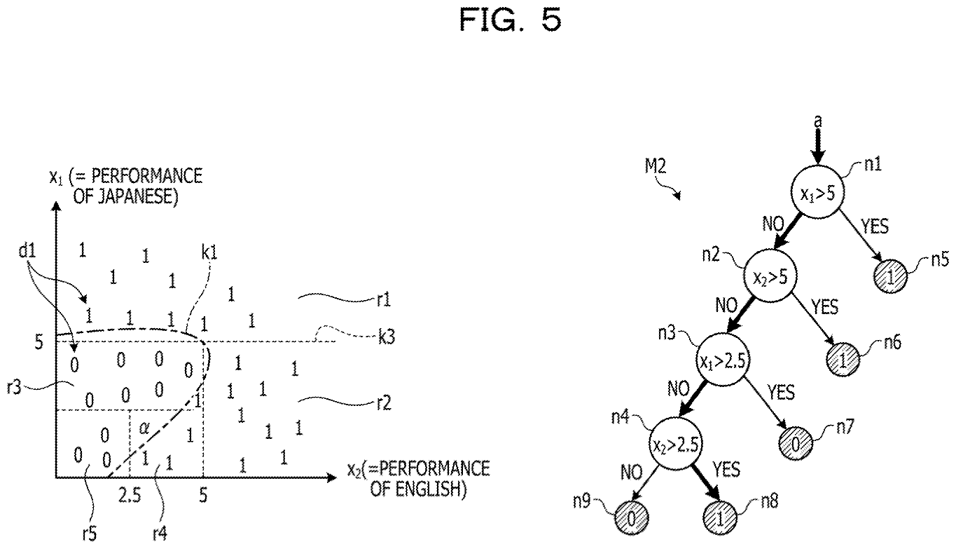

FIG. 5 is an explanatory diagram describing the creation of a decision tree. As illustrated in FIG. 5, the learning unit 32 creates a decision tree M2 by determining the branch conditions for the intermediate nodes (n1 to n4) so as to reach the terminal nodes (n5 to n9) associated with the labels (for example, “1” or “0” indicating the pass or fail of the examination) applied to the classification scores 11B. The number of the terminal nodes (n5 to n9) of the decision tree M2 and the like are set so as to make a boundary k3 in the decision tree M2 closer to the true boundary k1 by the adjustment of the hyperparameters by the hyperparameter adjustment unit 31.

In S4, the learning unit 32 classifies the learning data 11A by using the created decision tree M2 and associates the data d1, which are classified and clustered to the corresponding terminal nodes (n5 to n9), with the terminal nodes. For example, the learning unit 32 associates the data d1 of regions r1 to r5 classified to the corresponding terminal nodes (n5 to n9) with the terminal nodes.

For example, the data di of the region r1 classified to the node n5 is associated with the node n5. Likewise, the data d1 of the region r2 classified to the node n6 is associated with the node n6. The data d1 of the region r3 classified to the node n7 is associated with the node n7. The data d1 of the region r4 classified to the node n8 is associated with the node n8. The data d of the region r5 classified to the node n9 is associated with the node n9.

Referring back to FIG. 2 and following S4, the inference unit 33 executes the classification by the decision tree M2 for the classification target data 12 (S5) and identifies the terminal nodes associated with the classification target data 12 (S6).

Then, the inference unit 33 performs processing of identifying representative data out of the data d1 clustered to the identified terminal nodes (57).

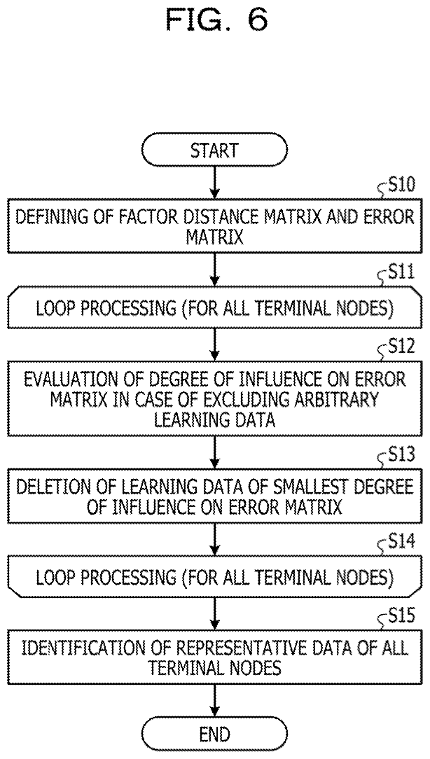

FIG. 6 is a flowchart exemplifying the processing of identifying the representative data. As illustrated in FIG. 6, once the processing is started, the inference unit 33 defines a factor distance matrix and an error matrix based on the classification scores 11B and the factor scores notified by the host learning device 2 (S10).

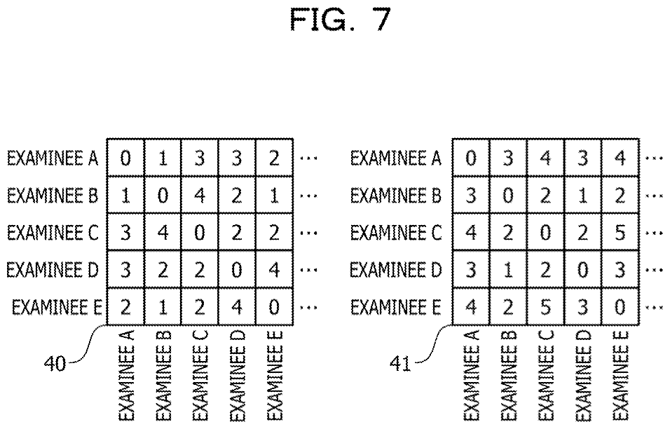

FIG. 7 is an explanatory diagram illustrating examples of the factor distance matrix and the error matrix. As illustrated in FIG. 7, a factor distance matrix 40 is a matrix in which a distance (a factor distance) between the factor scores of one examinee as oneself and the other examinee out of the sample examinees (“examinee A”, “examinee B” . . . ) in the learning data 11A is arrayed, Specifically, the factor distance matrix 40 is a symmetric matrix in which the factor distance between the one examinee and oneself is “0”. In the factor distance matrix 40 in FIG. 7, the factor distance between the “examinee D” and the “examinee E” is “4”. The inference unit 33 defines the factor distance matrix 40 by, for example, obtaining a distance between the vector data of oneself and the other examinee based on the vector data of the degrees of contribution of the performances of English and Japanese for each of the sample examinees.

An error matrix 41 is a matrix in which an error (for example, a distance between the classification scores of oneself and the other examinee) that occurs when the classification is performed with the classification score of the other examinee for each of the sample examinees (the “examinee A”, the “examinee B”, . . . ) in the learning data 10A is arrayed. Specifically, the error matrix 41 is a symmetric matrix in which the error between the one examinee and oneself is “0”. In the error matrix 41 in FIG. 7, the error that occurs when the classification of the “examinee A” is performed with the classification score of the “examinee C” is “4”. The inference unit 33 defines the error matrix 41 by, for example, obtaining the error based on the classification scores 116 for each of the sample examinees.

Referring back to FIG. 6, the inference unit 33 repeats loop processing until the specific learning data (the representative data) as the representative of the clusters of the number corresponding to the number of the terminal nodes that remain without being deleted from the defined factor distance matrix 40 and the error matrix 41 are obtained (S11 to S14). For example, the inference unit 33 repeats the processing of S12 and S13 until the representative data of the number corresponding to the number of the clusters of the terminal nodes remain without being deleted from the factor distance matrix 40 and the error matrix 41.

For example, once the loop processing is started, the inference unit 33 evaluates the degree of influence on the error matrix 41 in the case of deleting arbitrary learning data from the factor distance matrix 40 (S12).

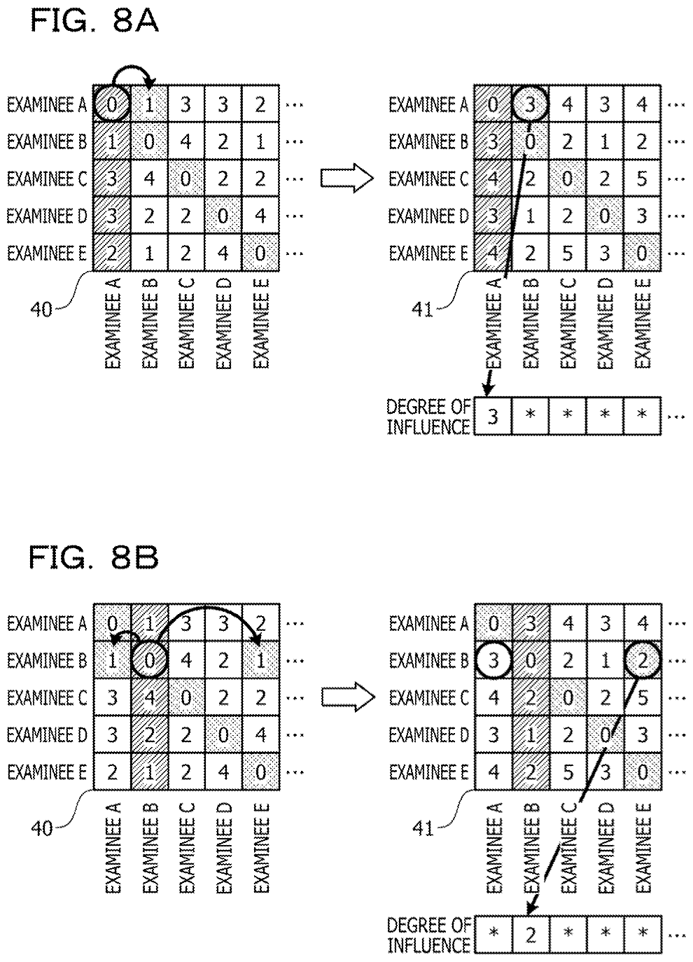

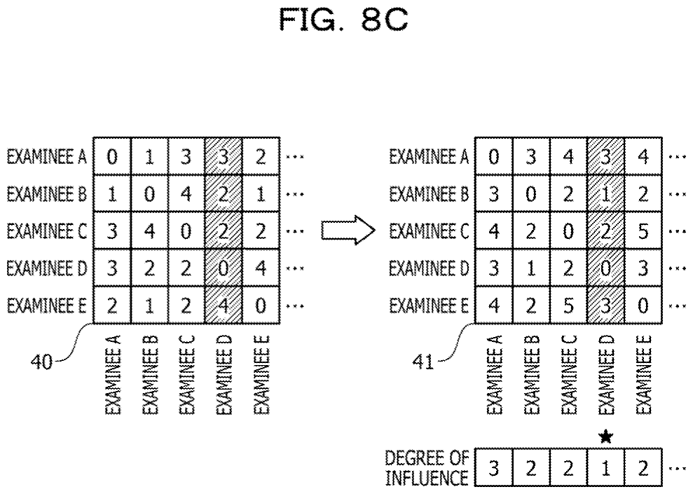

FIG. 8A and FIG. 86 are explanatory diagrams describing the evaluation of the degree of influence on the error matrix 41. As illustrated in FIG. 8A, here is assumed a case of excluding the “examinee A” from the factor distance matrix 40, for example. Based on the factor distances to the “examinee A” in the factor distance matrix 40, an examinee who has the factor closest to that of the “examinee A” is the “examinee B” with the factor distance of “1”. In this way, the inference unit 33 identifies data of the factor close to that of the data as the target of the deletion from the factor distance matrix 40.

Then, the inference unit 33 refers to the error matrix 41 and evaluates the error (the degree of influence) of a case of performing the classification with a classification score of the closest factor (the classification score of the other examinee). For example, since the “examinee B” is the person who has the factor closest to that of the “examinee A”, it is possible to see that, when the “examinee A” is excluded from the factor distance matrix 40 and the classification score of the “examinee B” is used, the error (the degree of influence) is increased by “3” based on the error matrix 41.

As illustrated in FIG. 8B, here is assumed a case of excluding the “examinee B” from the factor distance matrix 40, for example. Based on the factor distances to the “examinee B” in the factor distance matrix 40, examinees who have the factor closest to that of the “examinee B” are the “examinee A” and the “examinee E” with the factor distance of “1”. In this way, the inference unit 33 identifies data of the factor dose to that of the data as the target of the deletion from the factor distance matrix 40.

Then, the inference unit 33 refers to the error matrix 41 and evaluates the error (the degree of influence) of a case of performing the classification with a classification score of the closest factor (the classification score of the other examinee). For example, since the “examinee A” and the “examinee E” are the people who have the factor closest to that of the “examinee B”, it is possible to see that, when the “examinee B” is excluded from the factor distance matrix 40 and the classification scores of the “examinee A” and the “examinee E” are used, the error (the degree of influence) is increased by at least “2” based on the error matrix 41.

Referring back to FIG. 6 and following S12, based on the degree of influence evaluated in S12, the inference unit 33 deletes the learning data of the smallest degree of influence on the error matrix 41 from the factor distance matrix 40 and the error matrix 41 (S13).

FIG. 8C is an explanatory diagram describing the data deletion according to the degree of influence on the error matrix 41. As illustrated in FIG. 8C, the inference unit 33 deletes the “examinee D” who has the smallest degree of influence “1” from the factor distance matrix 40 and the error matrix 41. In this way, the remains in the factor distance matrix 40 and the error matrix 41 are four people, the “examinee A”, the “examinee B”, the “examinee C”, and the “examinee E”. As described above, the inference unit 33 repeats the loop processing until the number of the data (the representative data) that remains without being deleted becomes one in each duster.

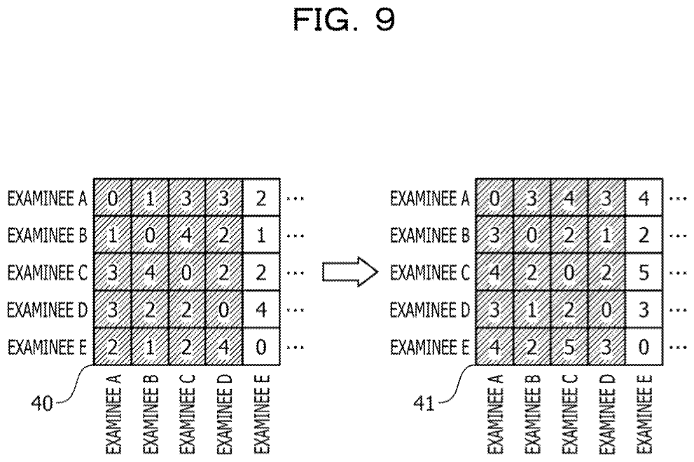

FIG. 9 is an explanatory diagram describing an example of the last remaining data. As illustrated in FIG. 9, one data d1 (the “examinee E” in the example in FIG. 9) remains without being deleted from the factor distance matrix 40 and the error matrix 41 by the loop processing (S11 to S14). The inference unit 33 sets the data d1 identified as described above as the representative data of the cluster (the terminal node).

Referring back to FIG. 6 and following the loop processing (S11 to S14), the inference unit 33 identifies the representative data (the remaining data without being deleted) of all the terminal nodes (n5 to n9) in the decision tree M2 (S15).

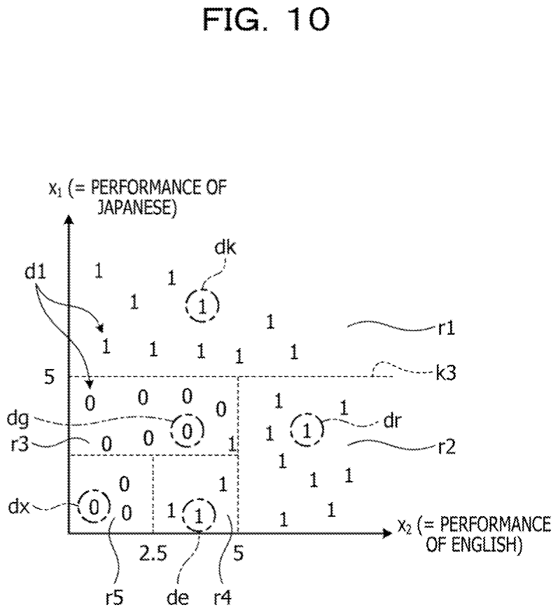

FIG. 10 is an explanatory diagram exemplifying the identification of the representative data. It is assumed that data corresponding to the “examinee K” remains without being deleted from the data d1 of the region r1 classified to the terminal node n5 for the learning data 10A as illustrated in FIG. 10. Accordingly, for the duster of the terminal node n5, the inference unit 33 identifies the data corresponding to the “examinee K” as representative data dk,

Likewise, the inference unit 33 identifies data corresponding to the “examinee R” as representative data dr from the data d1 of the region r2 classified to the terminal node n6 for the learning data 10A. The inference unit 33 identifies data corresponding to the “examinee G” as representative data dg from the data d1 of the region r3 classified to the terminal node n7 for the learning data 10A. The inference unit 33 identifies data corresponding to the “examinee E” as representative data de from the data d1 of the region r4 classified to the terminal node n8 for the learning data 10A. The inference unit 33 identifies data corresponding to the “examinee X” as representative data dx from the data d1 of the region r5 classified to the terminal node n9 for the learning data 10A.

Referring back to FIG. 2 and following 57, the inference unit 33 replaces the classification scores (for example, 100% pass/100% fail) of the terminal nodes (n5 to n9) of the decision tree M2 with the classification scores 116 as the prediction results of the learning model M1 of the identified representative data (de, dg, dk, dr, and dx) (S8).

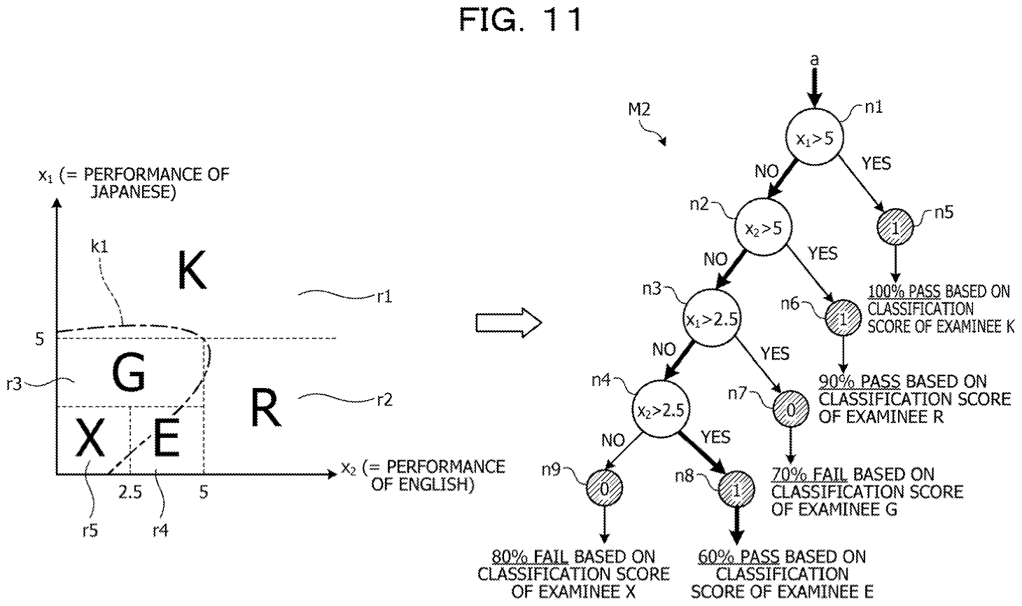

FIG. 11 is an explanatory diagram describing the replacement of the classification scores in the decision tree M2. As illustrated in FIG. 11, the inference unit 33 sets the classification scores 11B obtained by inputting the identified representative data (de, dg, dk, dr, and dx) into the learning model M1 as the classification scores for the terminal nodes n5 to n9 in the decision tree M2.

For example, for the terminal node n5, the inference unit 33 sets the 100% pass obtained by inputting the data of the “examinee K” as the representative data dk of the node n5 into the learning model M1 as the classification score. Likewise, for the terminal node n6, the inference unit 33 sets the 90% pass obtained by inputting the data of the “examinee R” as the representative data dr of the node n6 into the learning model M1 as the classification score. For the terminal node n7, the inference unit 33 sets the 70% fail obtained by inputting the data of the “examinee G” as the representative data dg of the node n7 into the learning model M1 as the classification score. For the terminal node n8, the inference unit 33 sets the 60% pass obtained by inputting the data of the “examinee E” as the representative data de of the node n8 into the learning model M1 as the classification score. For the terminal node n9, the inference unit 33 sets the 80% fail obtained by inputting the data of the “examinee X” as the representative data dx of the node n9 into the learning model M1 as the classification score.

As described above, with the replacement of the classification scores of the terminal nodes (n5 to n9) of the decision tree M2, the inference unit 33 is capable of outputting the prediction results (classification scores 1113) of the learning model M1 for the learning data 10A clustered to the identified terminal nodes as the prediction results of the identified terminal nodes. For example, the inference unit 33 is capable of outputting the classification scores of the representative data (de, dg, dk, dr, and dx) out of the learning data 10A clustered to the terminal nodes as the classification scores of the identified terminal nodes,

Referring back to FIG. 2 and following S8, the inference unit 33 outputs the results of the inference performed by the decision tree M2 as the classification results 13 for the classification target data 12 (S9) and terminates the processing. Specifically, the inference unit 33 outputs as the classification result 13 the classification scores of the terminal nodes identified by the decision tree M2 with the labels (for example, the pass or fail of the examination) of the terminal nodes.

As described above, the information processing system 1 obtains the learning model M1 in which the learning data 10A having the non-linear characteristics is learned by the supervised learning. The information processing system 1 creates the decision tree M2, which is a decision tree that includes the nodes and the edges in which the intermediate nodes are associated with the branch conditions and the terminal nodes are associated with the clustered learning data. The information processing system 1 identifies the terminal nodes associated with the classification target data 12 by following the intermediate nodes and the edges of the created decision tree M2 based on the inputted classification target data 12. The information processing system 1 outputs the prediction results obtained by applying the learning data associated with the identified terminal nodes to the learning model M1 as the prediction results of the identified terminal nodes.

Thus, with the information processing system 1, it is possible to obtain a more accurate prediction result than that of the decision tree M2 while maintaining the high interpretability achieved by the decision tree M2 by using the prediction results of the learning model M1.

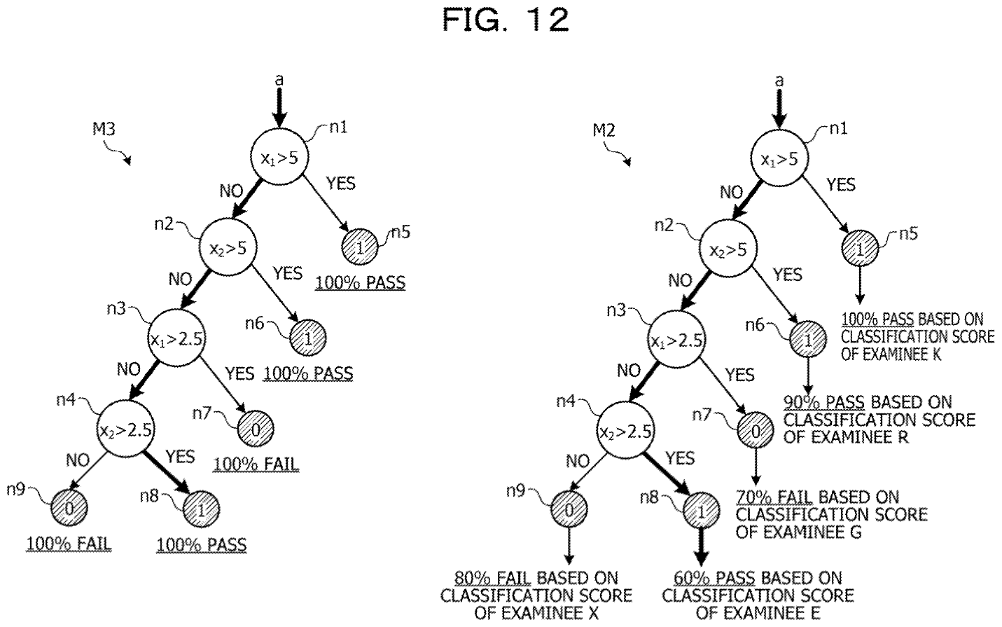

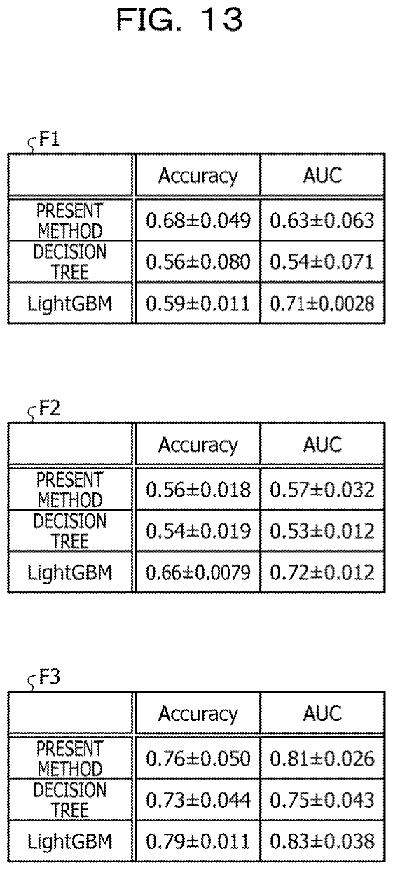

FIG. 12 and FIG. 13 are explanatory diagrams describing the comparison between the existing technique and the present embodiment. The left side of FIG. 12 exemplifies the classification of input data a using a decision tree M3 created by applying the existing technique. The right side of FIG. 12 exemplifies the classification of the input data a using the decision tree M2 created according to this embodiment. The input data a of the decision trees M2 and M3 are the same and that are, for example, the performances (Japanese (x₁), English (x₂)) of an “examinee a” or the like.

As illustrated in FIG. 11, with the decision tree M3 of the existing technique, it is possible to know which logic (branch conditions of the intermediate nodes on the way to the terminal node) is used to obtain the classification result by identifying any one of the terminal nodes n5 to n9 by following the intermediate nodes n1 to n4 based on the input data a. However, the classification result obtained with the decision tree M3 of the existing technique is only the pass or fail of the examination (100% pass or 100% fail).

On the contrary, in this embodiment, with the decision tree M2, it is possible to know which logic is used to obtain the classification result and also to obtain the classification score (for example, certainty of the pass or fail) of the learning model M1 for the learning data clustered to the identified terminal nodes n5 to n9. Specifically, according to this embodiment, since it is possible to obtain not only the pass or fail of the examination but also the certainty of the pass or fail (for example, the node n7 is 70% fail), it is possible to obtain a more accurate prediction result than that of the classification with the existing decision tree M3.

FIG. 13 exemplifies Experimental Examples F1 to F3 in which the free datasets of kaggle are used to obtain Accuracy, or area under the curve (AUC), which is an evaluation value of the machine learning. For example, evaluation values of a method according to this embodiment (present method), a method using only a decision tree (decision tree), and a method using only the LightGBM that is a kind of GBTs are obtained and compared with each other for the free datasets.

Experimental Example F1 is an experimental example using a free dataset of a binary classification problem designed to implement overlearning (www.kaggle.com/c/dont-overfit-ii/overview). Experimental Example F2 is an experimental example using a free dataset of a binary classification problem related to the transaction prediction (www.kaggle.com/lakshmi25npathi/santander-customer-transaction-prediction-dataset). Experimental Example F3 is an experimental example using a free dataset of a binary classification problem related to a heart disease (www.kaggle.com/ronitf/heart-disease-uci). In Experimental Examples F1 to F3, the evaluation values are obtained based on an average value of ten trials of the learning and the inference.

As illustrated in FIG. 12, in any of Experimental Examples F1 to F3 with the present method, although some cases fall short of the LightGBM that is capable of making closer to the true boundary, it is possible to obtain the classification result with a higher accuracy than that using the decision tree.

The information processing system 1 outputs the prediction results of the learning model M1 of the representative data (de, dg, dk, dr, and dx) representing the clusters out of the learning data clustered to the identified terminal nodes. Thus, with the information processing system 1, it is possible to obtain the prediction results of the learning model M1 based on the representative data of the clusters of the terminal nodes identified by the decision tree M2.

The representative data is data obtained by deleting the learning data of a small degree of influence on the error from the learning data, based on the errors of the learning data clustered to the identified terminal nodes in the case of the classification with the learning data having close scores of the factors of the obtainment of the classification results. Thus, with the information processing system 1, it is possible to obtain the prediction result by using the representative data that is obtained by the clustering of the learning data having similar factors.

The prediction result to be outputted is the score information (the classification score) related to the classification of the learning data obtained by inputting the learning data into the learning model M1. Thus, with the information processing system 1, it is possible to obtain the score information (the classification score) obtained by the learning model M1 as the prediction result.

The learning model M1 is either of a gradient boosting tree and a neural network. Thus, with the information processing system 1, it is possible to obtain a more accurate prediction result than that using a decision tree by using either of a gradient boosting tree and a neural network.

The components of parts illustrated in the drawings are not necessarily configured physically as illustrated in the drawings. For example, specific forms of dispersion and integration of tile parts are not limited to those illustrated in the drawings, and all or part thereof may be configured by being functionally or physically dispersed or integrated in given units according to various loads, the state of use, and the like. For example, the hyperparameter adjustment unit 21 and the learning unit 22, or the hyperparameter adjustment unit 31 and the learning unit 32 may be integrated with each other. The order of processing illustrated in the drawings is not limited to the order described above, and the processing may be simultaneously performed or the order may be switched within the range in which the processing contents do not contradict one another.

All or any of the various processing functions performed in the devices may be performed on a central processing unit (CPU) (or a microcomputer such as an MPU or a microcontroller unit (MCU)). It is to be understood that all or any part of the various processing functions may be executed on programs analyzed and executed by a CPU (or a microcomputer such as an MPU or an MCU) or on hardware using wired logic. The various processing functions may be enabled by cloud computing in which a plurality of computers cooperate with each other.

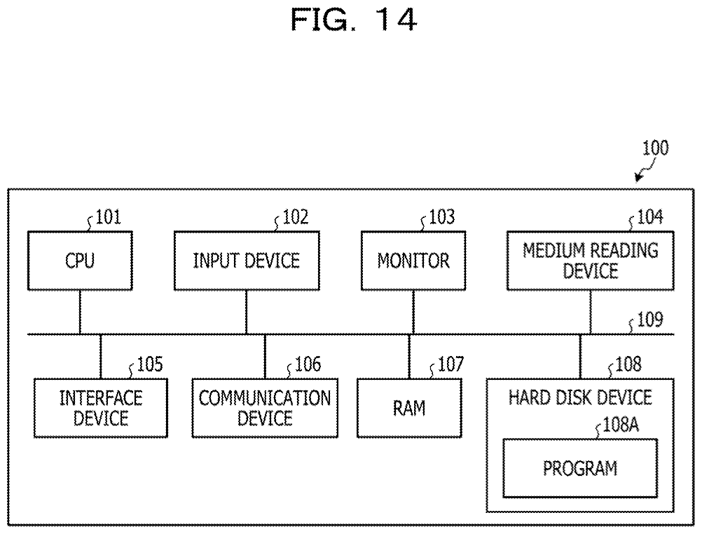

The various processing described above in the embodiments may be enabled by causing a computer to execute a program prepared in advance. An example of a computer that executes a program having the similar functions as those of the above-described embodiments is described below. FIG. 14 is a block diagram illustrating an example of the computer that executes the program,

As illustrated in FIG. 14, a computer 100 includes a CPU 101 that executes various arithmetic processing, an input device 102 that receives data input, and a monitor 103. The computer 100 includes a medium reading device 104 that reads a program and the like from a storage medium, an interface device 105 to be coupled with various devices, and a communication device 106 to be coupled to another information processing device or the like by wired or wireless communication. The computer 100 also includes a RAM 107 that temporarily stores various information and a hard disk device 108. The devices 101 to 108 are coupled to a bus 109.

The hard disk device 108 stores a program 108A having the functions similar to those of the processing units (for example, the hyperparameter adjustment units 21 and 31, the learning units 22 and 32, the inference units 23 and 33, and so on) in the information processing system 1 illustrated in FIG. 1. The hard disk device 108 stores various data for implementing the processing units in the information processing system 1. The input device 102 receives input of various kinds of information such as operation information from a user of the computer 100, for example. The monitor 103 displays various kinds of screens such as a display screen, for the user of the computer 100, for example. To the interface device 105, for example, a printing device is coupled. The communication device 106 is coupled to a not-illustrated network and transmits and receives various kinds of information to and from another information processing device.

The CPU 101 executes various processing by reading out the program 108A stored in the hard disk device 108, loading the program 108A on the RAM 107, and executing the program 108A. These processes may function as the processing units (for example, the hyperparameter adjustment units 21 and 31, the learning units 22 and 32, the inference units 23 and 33, and so on) in the information processing system 1 illustrated in FIG. 1.

The above-described program 108A may not be stored in the hard disk device 108. For example, the computer 100 may read and execute the program 108A stored in a storage medium readable by the computer 100. The storage medium readable by the computer 100 corresponds to, for example, a portable recording medium such as a CD-ROM, a digital versatile disc (DVD), or a Universal Serial Bus (USB) memory, a semiconductor memory such as a flash memory, or a hard disk drive. The programs 108A may be stored in a device coupled to a public network, the Internet, a LAN, or the like, and the computer 100 may read and execute the programs 108A from the device.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An inference method causing a computer to execute a process comprising:
obtaining a learned model in which learning data having on-linear characteristics is learned by supervised learning;
creating a decision tree that includes nodes and edges in which intermediate nodes are associated with branch conditions and terminal nodes are associated with clustered learning data;
identifying a terminal node associated with classification target data by following the intermediate nodes and the edges of the created decision tree based on the inputted classification target data; and
outputting a prediction result obtained by applying the learning data associated with the identified terminal node to the learned model as a prediction result of the identified terminal node.

2. The inference method according to claim 1, wherein
the outputting is to output a prediction result of the learned model for a specific learning data as a representative of the learning data associated with the identified terminal node.

3. The inference method according to claim 2, wherein
the identified learning data is data obtained by deleting the learning data of a small degree of influence on an error from the learning data, based on each error of the learning data clustered to the identified terminal node in a case of the classification with learning data having close scores of factors of the obtainment of the classification result.

4. The inference method according to claim 1, wherein
the prediction result is score information on the classification of the learning data obtained by inputting the learning data into the learned model.

5. The inference method according to claim 1, wherein
the learned model is either of a gradient boosting tree and a neural network.

6. A non-transitory computer-readable storage medium having stored an inference program causing a computer to perform a process comprising:
obtaining a learned model in which learning data having non-linear characteristics is learned by supervised learning;
creating a decision tree that includes nodes and edges in which intermediate nodes are associated with branch conditions and terminal nodes are associated with clustered learning data;
identifying a terminal node associated with classification target data by following the intermediate nodes and the edges of the created decision tree based on the inputted classification target data; and
outputting a prediction result obtained by applying the learning data associated with the identified terminal node to the learned model as a prediction result of the identified terminal node.

7. The storage medium according to claim 6, wherein
the outputting is to output a prediction result of the learned model for a specific learning data as a representative of the learning data associated with the identified terminal node.

8. The storage medium according to claim 7, wherein
the identified learning data is data obtained by deleting the learning data of a small degree of influence on an error from the learning data, based on each error of the learning data clustered to the identified terminal node in a case of the classification with learning data having close scores of factors of the obtainment of the classification result.

9. The storage medium according to claim 6, wherein
the prediction result is score information on the classification of the learning data obtained by inputting the learning data into the learned model.

10. The storage medium according to claim 6, wherein
the learned model is either of a gradient boosting tree and a neural network.

11. An information processing device comprising:
a memory, and
a processor coupled to the memory and configured to:
obtain a learned model in which learning data having non-linear characteristics is learned by supervised learning;
create a decision tree that includes nodes and edges in which intermediate nodes are associated with branch conditions and terminal nodes are associated with clustered learning data;
identify a terminal node associated with classification target data by following the intermediate nodes and the edges of the created decision tree based on the inputted classification target data; and
output a prediction result obtained by applying the learning data associated with the identified terminal node to the learned model as a prediction result of the identified terminal node.

12. The information processing device according to claim 1, wherein
the output is to output a prediction result of the learned model for a specific learning data as a representative of the learning data associated with the identified terminal node.

13. The information processing device according to claim 2, wherein
the identified learning data is data obtained by deleting the learning data of a small degree of influence on an error from the learning data, based on each error of the learning data clustered to the identified terminal node in a case of the classification with learning data having close scores of factors of the obtainment of the classification result.

14. The information processing device according to claim 1, wherein
the prediction result is score information on the classification of the learning data obtained by inputting the learning data into the learned model.

15. The information processing device according to claim 1, wherein
the learned model is either of a gradient boosting tree and a neural network.
